(19) United States
(12) Patent Application Publication
(10) Pub. No.: US 2024/0364801 A1
(43) Pub. Date: Oct. 31, 2024

(54) DEVICE FOR PICKING UP, HOLDING AND HANDLING INPUT/DISPLAY UNITS

(71) Applicant: PLANETE, CRETEIL (FR)

(72) Inventor: Youcef MOSTEFAÏ, CRETEIL (FR)

(21) Appl. No.: 18/566,348

(22) PCT Filed: Jun. 3, 2022
(86) PCT No.: PCT/FR2022/051069

§ 371 Date: Dec. 1, 2023

(30) Foreign Application Priority Data
Jun. 5, 2021 (FR) 2105938

(51) Int. Cl. H04M 1/04; H04M 1/02

(52) U.S. Cl. CPC H04M 1/04; H04M 1/0266

(57) ABSTRACT

The invention relates to a device (1), having non-collinear rods, for picking up with one hand, either the left hand or the right hand, regardless of whether it is large or small, an input/display unit having one or two sections. It is made up, with regard to its part that is visible when it is in a (vertical) use position, of two oblique rods (4) that are fixed to the back (2) and around the sagittal plane (26) of the casing (3) in the case of a unit with one section, so as to make it possible to slide the fingers under these oblique rods (4) and to close up the fingers on either side of the base of the device (1), this having the effect of securing the casing (3) to the hand, therefore making it possible to hold and handle the casing effortlessly. The device according to the invention is particularly intended for tablets, e-readers and laptop computers.

The present invention relates to a device facilitating picking up, holding and handling of small manufactured objects, particularly those in the form of casings and used for viewing and/or inputting information.

The handling of these casings is traditionally improved by the addition of a device attached to the back of these casings in order to allow them to be held (particularly when they do not stay in the palm of the hand, which therefore cannot surround them by their two by vertical “sections”, in other words by the narrow faces of the casing when it is sufficiently small, such as that of a cell phone). Thus, the casing and hand are rigidly connected, with the latter being trapped, on one side by the back of said casing on which the palm is planted and, on the other hand, by the “top part” (see below) of the device that itself presses on the back of the hand. These devices generally have their visible part (comprising a “top part” and “bottom part”) in a shape that is more or less approximately a “T” (a variant of which has the appearance of a mushroom, where the “top part” is the horizontal bar of the “T” in one case, and the “hat”, in the other, and the “bottom part”, the vertical bar of the “T” and the foot of the mushroom, respectively), in inverted “U” form (one “gantry” therefore, sometimes accompanied by a “bracket”, with an “L” also inverted, with the gantry serving for the actual fingers and, the arm, for the thumb), or also in the form of an “O” (a ring wherein the finger is passed) . . . When the visible part of the device is in the form of an inverted “T” or “L”, the upper part of the device is a “segment” assumed to have the horizontality of the “T” bar (horizontality supposed to also be that of the back of the casing throughout the text that follows, unless otherwise indicated, explicitly or implicitly), the lower part of the device then being a vertical segment since it is implanted perpendicularly to the back (assumed to be horizontal, see above) of the casing. Therefore, this lower, vertical part is provided so that the hand surrounds it in one of its interdigital spaces; it can then constitute an axis around which there is a risk of the casing being in rotation. In certain ways of gripping the device, the upper, horizontal part can constitute, itself, an axis of rotation, not less damaging to good holding of the casing.

There is also lack of mastery for other reasons and for other types of devices, firstly because they are not at the precise size of the fingers of the person handing of the casing, hence a clearance driving a floating holding. This is obvious for the ring device, unless there is a ring customized to all possible fingers, etc. and that it would be necessary to change it each time the finger acted upon is too fatigued. For the device with gantry and arm, in addition to the height not adaptable to the dimension of the fingers, there is the distance between the ring and the arm, which only corresponds to a single size (width) of the hand. One solution has been that where the device has a shape closely resuming that of the “T”, a “T” in three dimensions of course, the bars of the letter being replaced by cylinders. The vertical part of the device is then composed of segments, in variable numbers and lengths, used to modulate the length thereof to adjust it to the diameter of the fingers. However, this length can only be adapted roughly (typically, in two-millimeter steps), the segments to be used being determined and mounted to constitute, at the desired length, the vertical part of the device, the assembly which is not just carried out once, during the first use of the device, the segments being chosen to place this vertical part at the size of the fingers of the first and assumed to be the unique or main user of the device. But, and it is another reason for poor control of the casing, the diameters of fingers of the hand are all different and the adjustment that is appropriate to the dimension of one is not suitable for that of the neighboring finger. And what is adapted to one of the interdigital spaces (and to the two fingers concerned) is, necessarily, unsuitable for others (and to the two fingers involved in these other occasions). The problem is even more complicated since the diameters of fingers are different between the right hand and the left hand, with the progression of the diameter of the fingers, in addition, in the opposite direction by changing the mobile hand for handling the casing. Changing the hand manipulating the casing is, indeed, a welcome facilitation but, before even this, there is the need to change the interdigital space wherein the vertical part of the device is inserted, and also the obligation not to hold the hand too long in the same position, with stretched fingers, constantly pressed against the back of the casing; thus is constrained by the taking into account of physiological realities that require the fight against fatigue, ankylosis, sweating, etc. of the hand.

The fatigue, quite particular, is that inherent to the handling of large casings or appliances with two sections, going with the weight, which would require the installation of two devices close to each other, but such installation cannot be envisaged for the reason of fixed supported dimension of the fingers which has just been recalled, as well as that of their spacing, varying with the dimension of the hands.

On the other hand, when the device must be folded, thanks to an appropriate mechanism, in a recess arranged on the back of the casing (that is the non-visible part of the device), this recess must be sufficiently large to suit all the dimensions of the device, its width remaining fixed (defined by the dimension of the horizontal top part of the device (the horizontal bar of the “T”, etc.) but its length varying to be suitable for all the possible lengths of the vertical bottom part, modulated by the number of sections provided and their combination supported (in fact, mobilizing all of the sections provided by the manufacturer for the same configuration of the vertical part may not make sense). This implies a recess with a maximum dimension remaining, in addition, largely empty (it is occupied by the device in its length defined by the assembly preceding the first use (see above), the rest of the recess remaining empty until any other adjustment that would affect another part). Therefore, this excess bulk doubles the presence of asperities, that of the edges of the part of the recess remaining unoccupied after the visible part of the device has been folded therein.

The device according to the invention makes it possible to remedy these disadvantages (as such they appear in the “T”-shaped device of application No. FR1904609/Publication number FR3095359). Indeed, according to a first characteristic, it comprises a visible part, contained in a plane vertical to that of the back of the input/display casing on which it is installed, in the form of an uppercase “V” in three dimensions. The two oblique rods of the letter are therefore two cylinders. They are rounded at one of their ends and join together, at the bottom of the letter, this visible part of the device being extended by an invisible part, buried inside the casing. This obliquity of the rods of the device makes it possible to adjust its dimensions to those of the diameter of the fingers of the hand manipulating the casing by the same skew. Indeed, the fingers find the place suitable for their diameter by moving away or approaching the axis of symmetry of the device, while maintaining contact with the oblique rods. Since the fingers are always in contact with the oblique rods which overhang them and stress them, they, but also the entire hand, are rigidly connected, pressing on the back of the casing, the latter being stabilized, preventing inappropriate translational and rotational movement. The device, comfortable for this adaptation for all dimensions of the hand, the left and the right, also allows the setting according to varied modalities (thus by that of a hand whose palm is folded partially (as a “dome”, see below, which allows the evaporation of perspiration and, here again, ensures a stabilized hold) or totally (the device is then clamped in the closed fist, see below). It avoids the accidental rotation of the casing, by the mobilization of three fingers for its setting and also because its upper part consists of two oblique rods that can constitute an axis of rotation (as in the case of a device whose visible part is that of a “T”). It does not cause unnecessary bulk, completely filling the volume of its storage recess and thus leaving the back of the casing free of asperities.

An object of the present invention relates to a device for gripping, holding in the hand and handling of input/display units characterized in that it consists, for its visible part when in its vertical use position, of two non-collinear rods, two cylindrical oblique rods attached vertically to the back of the casing, having the appearance of the letter “V”, oblique rods under which the fingers slide so that the hand is sandwiched, the back against the bottom of the oblique rods and, the palm, against the back of the casing, which has the effect of securing the hand with the casing, the outlet being reinforced by the natural movement bearing the fingers to be clamped against one another and thus enclosing the base of the device where the two oblique rods meet, which results in holding the casing secured to the hand, the device being released and, with it, the casing, as soon as an effort is exerted to separate the fingers enclosing the base of the device.

According to particular embodiments:
the rods of the device installed on the back of the input/display unit casings, non-collinear and giving the symmetric image of the letter “V”, can be sufficiently long and/or inclined to be adapted to all finger sizes, the fingers finding the suitable place by moving away from the axis of symmetry of the device as it increases their diameter.
the junction of the two oblique rods, at the bottom of the axis of symmetry of the “V”, can be extended by a vertical rod, then giving the device the appearance of a “Y”.
the two oblique rods can form a butterfly element intended to be rotated around the axis of symmetry of the device to ensure better engagement of the casing.
the bottom of the device can be extended in an invisible part when said device is in its vertical position of use, an invisible part comprising, perpendicular to the axis of symmetry of the device, an axis of rotation around which it can rotate to exit its vertical position of use, for the storage that is flat and horizontal, concealed by retraction in a recess arranged on the back of the casing, the shape of this recess being able to be that of a “Y”.
two horizontal tabs and two vertical tabs are respectively cut on side walls of the recess opposite to each other, the two horizontal tabs being arranged opposite each other and the two vertical tabs being arranged opposite each other, the horizontal tabs being configured to be protruding and in contact with the part invisible when the device is in its vertical position of use so as to stabilize the device in the vertical position of use, the vertical tabs being configured to be protruding and in contact with the visible part when the device is in its horizontal retracted and storage position so as to stabilize the device in the horizontal retracted and storage position, the horizontal and vertical tabs being further configured to allow a rotation of the device of the vertical position of use in the horizontal retraction and storage position, and vice versa, when a force making it possible to overcome the stabilization exerted by the tabs is applied to said device.
the lateral walls of the retraction recess, at the location where they frame the invisible part of the device, may be provided with horizontal tabs, preferably rectangular, cut out on three of their sides in order to be able to enter these walls when the invisible part of the device pushes them in order to access its vertical position of use, before exiting, as soon as this vertical position is reached, and then to stabilize the device in this vertical position until a sufficient force is applied to the device to bring it to its retracted and storage position, rotational movement which again returns the horizontal tabs in the wall of the recess in order to allow the passage of the device for access to the horizontal retracting and storage position, a position which, to be reached, brings in the vertical tabs, preferably rectangular, cut out, on three of their sides, on both sides on the other side walls of the part of the recess containing the vertical rod or cut, on three of their sides, on either side of the side walls of the part of the recess containing the oblique rods, vertical tabs which emerge from the side walls of the recess as soon as the horizontal position is reached by the device, which they then block in this retracted storage position until a force is applied to remove it in order to make it reach the vertical position of use.
the invisible part has the shape of a cylinder with an axis of revolution corresponding to an axis of symmetry of the device, the invisible part comprising a front half-cylinder and a rear half-cylinder, the bottom of the front half-cylinder being trimmed to take the appearance of a quarter of a sphere framed by two abutment surfaces formed by two first isosceles rectangle triangles with movable curvilinear hypotenuse, the bottom of the rear half-cylinder being trimmed so as to have a contact surface always tangent inside the rear face of the recess during the rotation of the device, the recess further comprising a part formed by two isosceles second rectangle triangles with fixed curvilinear abutment hypotenuse, meant to enter in contact with the two opposite abutment positions (33), when the device, in rotation, reaches its vertical position of use, preventing the device from rotating the driving element beyond its vertical position of use.
The bottom of the invisible part of the device can be, by default (by removal of material), rounded to have a quarter of a sphere for its front part and, for its rear part, curved to have a left double-curvilinear triangle on the horizontal cylinder surface, so as to always be in contact, during its rotation, the driving element from the horizontal retracted position to the vertical position of use and vice versa, still in contact with the inner wall of the rear of the retraction recess, the bulk of which is thus reduced. The flare of the front part is configured to allow the rotation of the device as close as possible to the lower face of the retraction recess, so as to be able to reduce the depth of the retraction recess. The invisible part and the recess may further be configured to have abutment surfaces intended to cooperate to prevent over-rotation of the device beyond an angle of about 90° corresponding to the vertical position of use of the device, the abutment surfaces of the recess being further configured to allow the passage of the quarter sphere part present on the front half-cylinder during the rotation of the device between the two positions.
the invisible part of the device has a diameter greater than a reference diameter of the visible part of the device, the corresponding reference diameter, or the diameter of a vertical rod being located under a junction of the two oblique rods, or the diameter of the two oblique rods, in the absence of a vertical rod under the junction of the two oblique rods.
the invisible part of the device can be enlarged, homothetically, and its mechanical properties can be improved, while remaining flush with the recess. The part of the recess containing this enlarged invisible part is in turn enlarged accordingly. The enlarged invisible part remains in contact with the inner wall of the rear face of the recess, while the visible part of the device in the vertical position of use remains vertically above the recess. Due to its enlargement, this so-called invisible part as concealed by the recess becomes partially visible in the top view when the device is in the vertical position of use.
in the case of heavy-casing devices or two sections, the device can be attached in a double copy on one or both of the two sections, so as to continue to be used, one and/or the other, one and/or the other taken in its (their) interdigital space, or as constituting a single device used with spread fingers, and even by the thumb and the little finger applied on the two devices as they were on a third, virtual one and whose diameter of the base formed by the vertical rod would be equal to the sum of those of the bases, that is vertical rods, devices, increased by the distance separating the two devices.

The attached drawings show the invention:

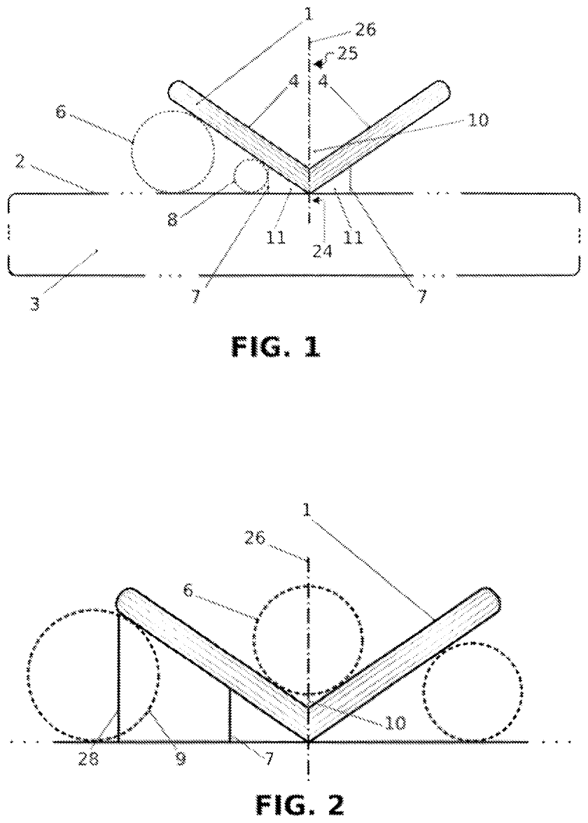

FIG. 1 shows the device of the invention, its two rods combined in form of a “V” installed on the back of an input/display unit casing.

FIG. 2 shows the use of the device with three fingers.

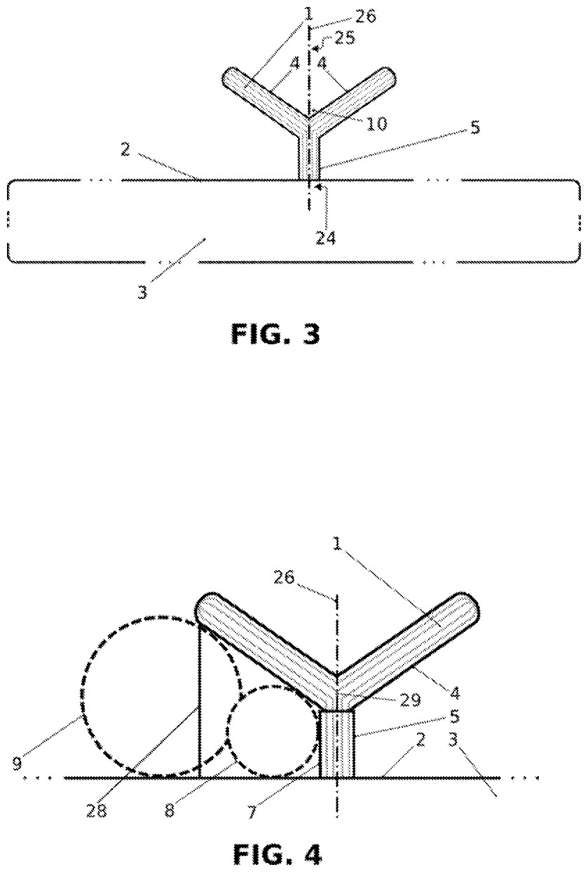

FIG. 3 shows a variant, in the form of a “Y”, of this device.

FIG. 4 shows the way in which the use of the space under the oblique rods of the device is optimized.

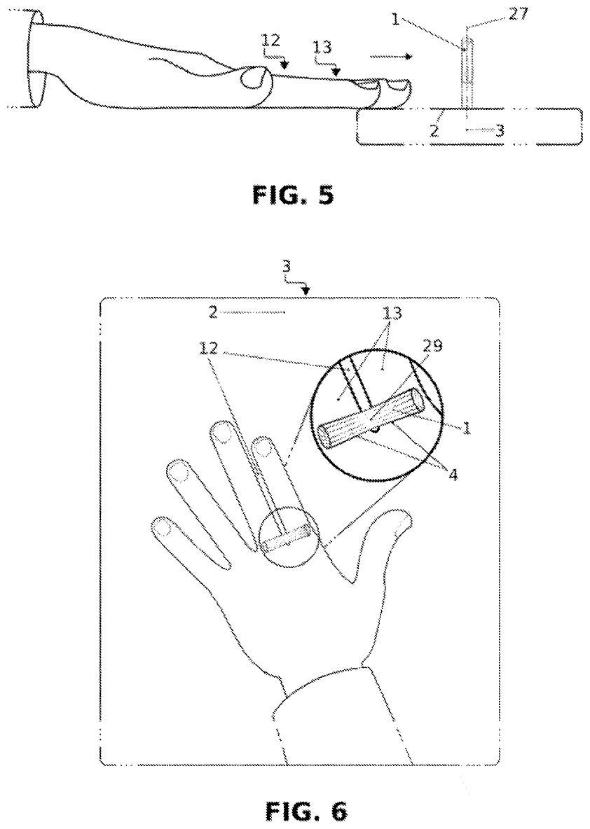

FIG. 5 shows a hand on approaching the device before inserting it into an interdigital space

FIG. 6 shows the device inserted into the interdigital space of one hand.

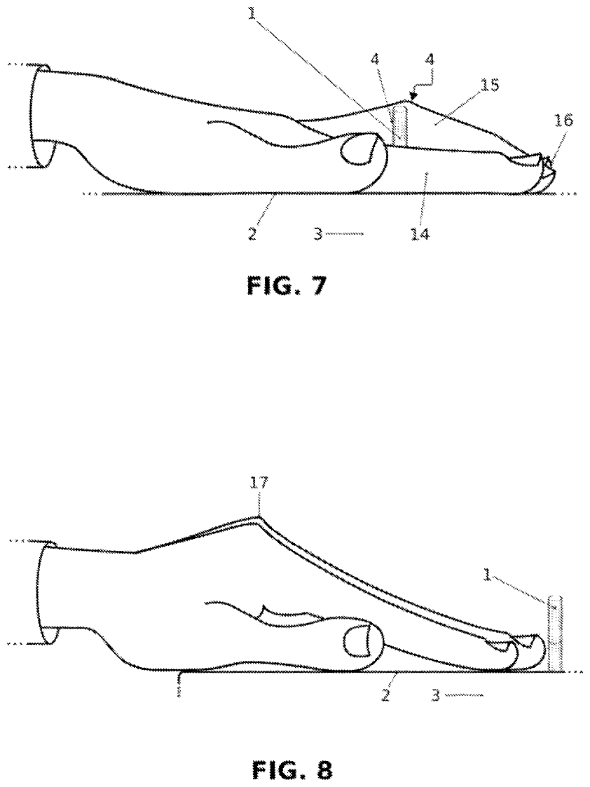

FIG. 7 shows the use of the device using three fingers.

FIG. 8 shows the use of the device using a dome-placed hand to eliminate perspiration, evacuate any fatigue by a change of grip.

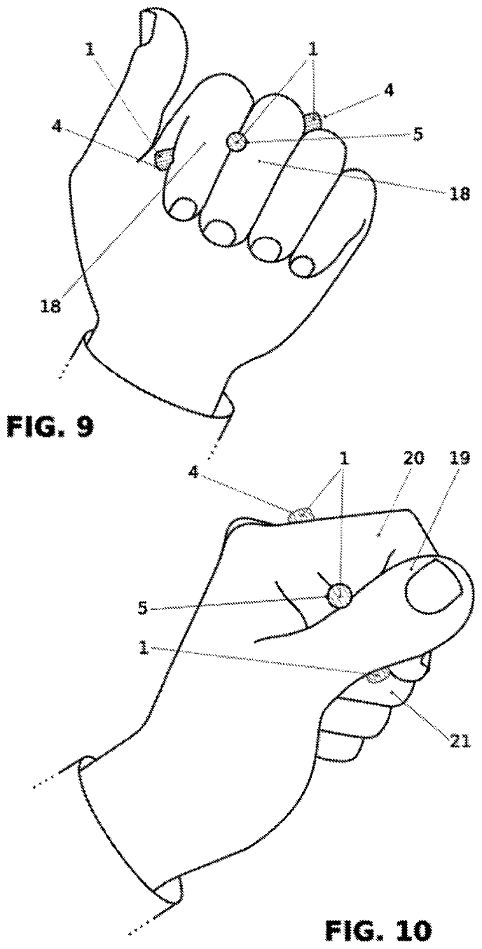

FIG. 9 shows the use of the device using a closed hand, the vertical rod of the device between the median phalanges.

FIG. 10 shows the use of the device using a closed hand, the vertical rod of the device between the thumb and the index finger.

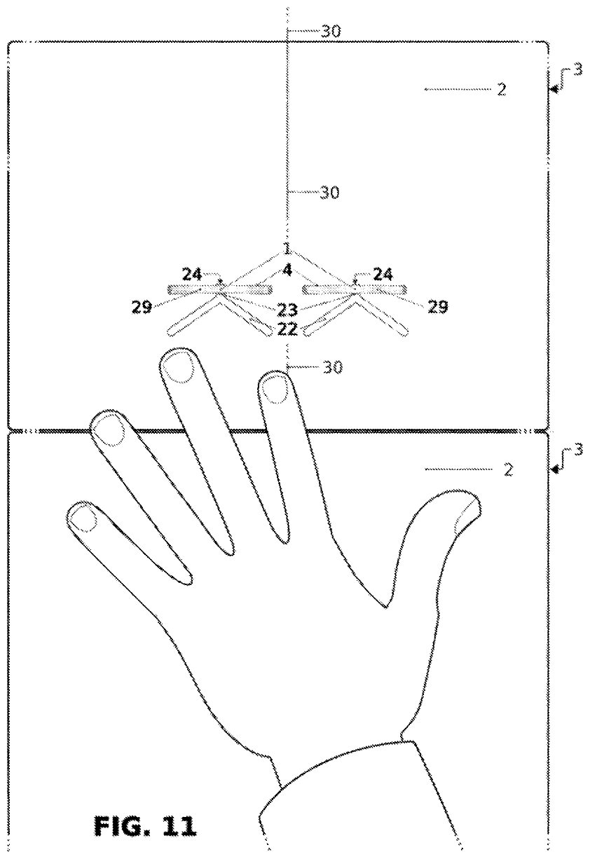

FIG. 11 shows the use of two “V” devices installed on an device casing back with two sections with horizontal articulation provided with two recesses wherein the devices are retracted to be stowed (horizontally) when they are not used (vertically).

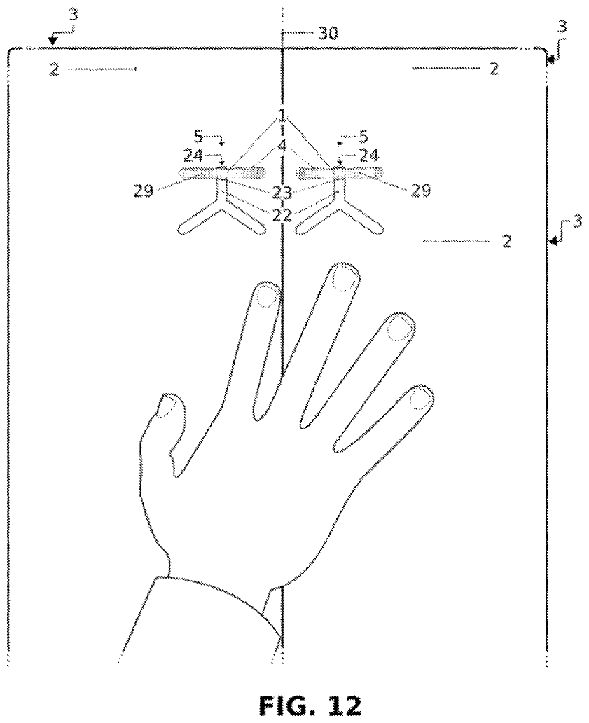

FIG. 12 shows the use of two “Y” devices installed on two back of the device casings with two sections with vertical articulation provided with two recesses wherein the devices are retracted to be stowed (horizontally) when they are not used (vertically).

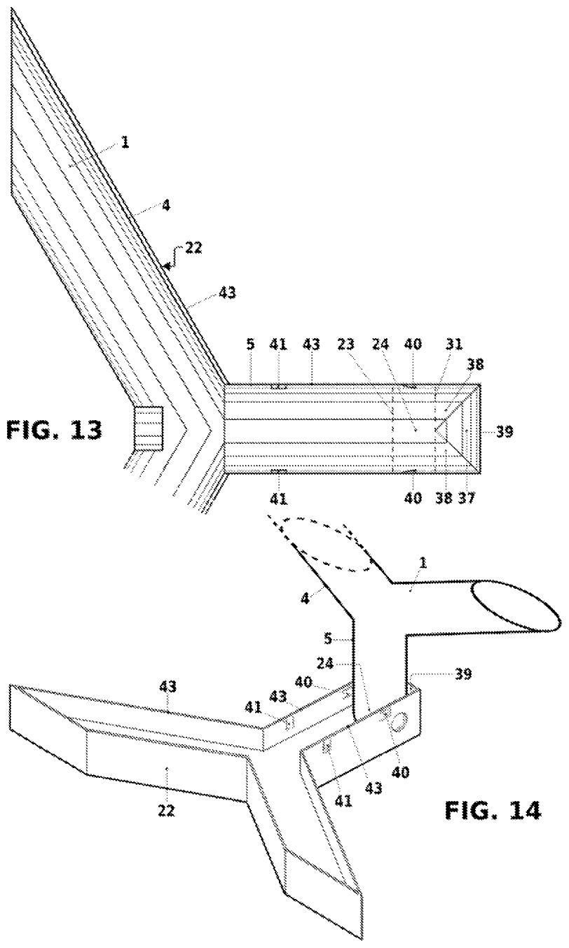

FIG. 13 shows, seen from above, a variant of the device in the horizontal position in the retraction recess.

FIG. 14 shows, seen in perspective, the device of FIG. 13 in the vertical position of use, with the part invisible in the retraction recess.

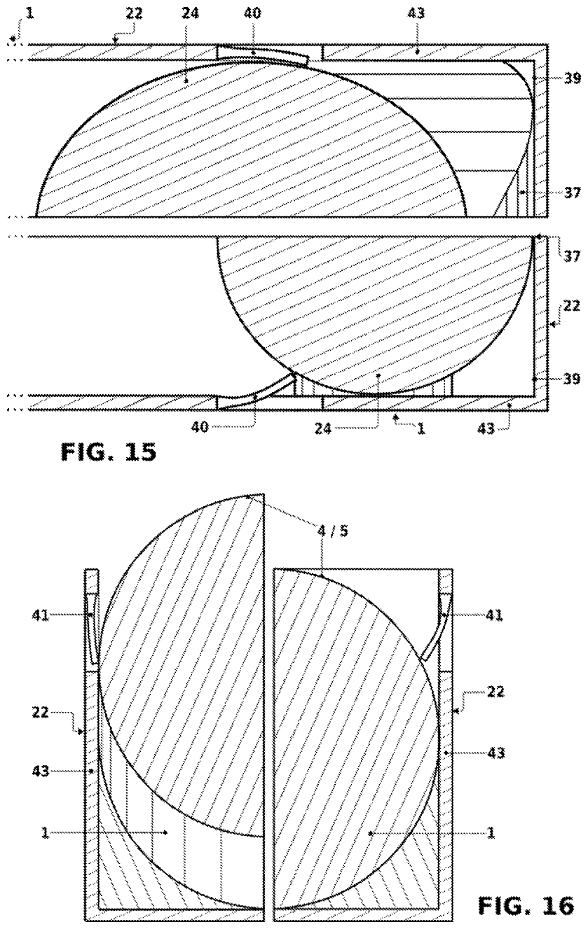

FIG. 15 shows, in two sections along a plane tangent to the upper face of the horizontal rectangular tabs, the device in its recess, in the oblique position approaching the vertical for the first section, and in the vertical position of use reached in the second section.

FIG. 16 shows, in two sections along a plane tangent to the front face of the vertical rectangular tabs, the device in its recess, in the oblique position approaching the horizontal for the first section, and in the horizontal storage position reached in the second section.

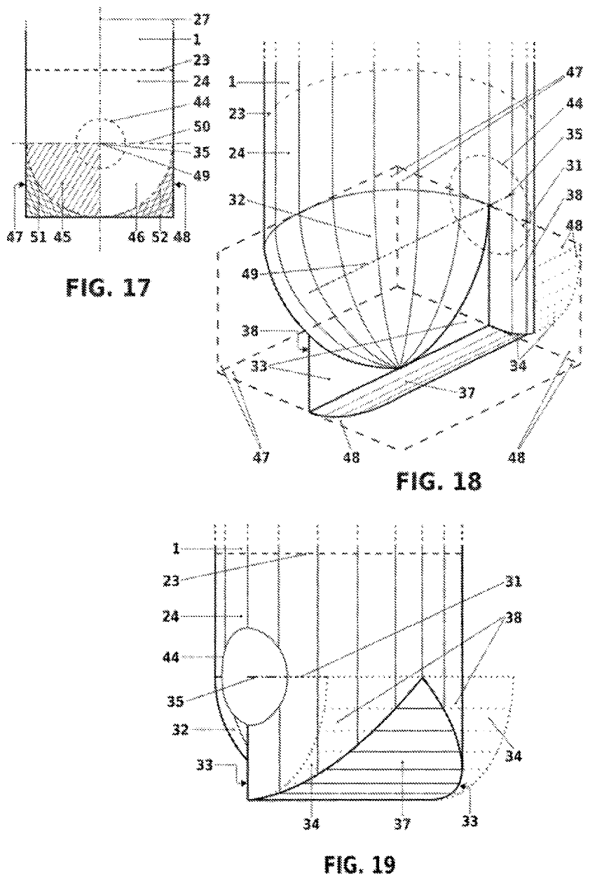

FIG. 17 represents a right view centered on the invisible part of the device.

FIG. 18 shows the device, in a view centered on the front of the invisible part.

FIG. 19 shows the device, in a view centered on the rear of the invisible part.

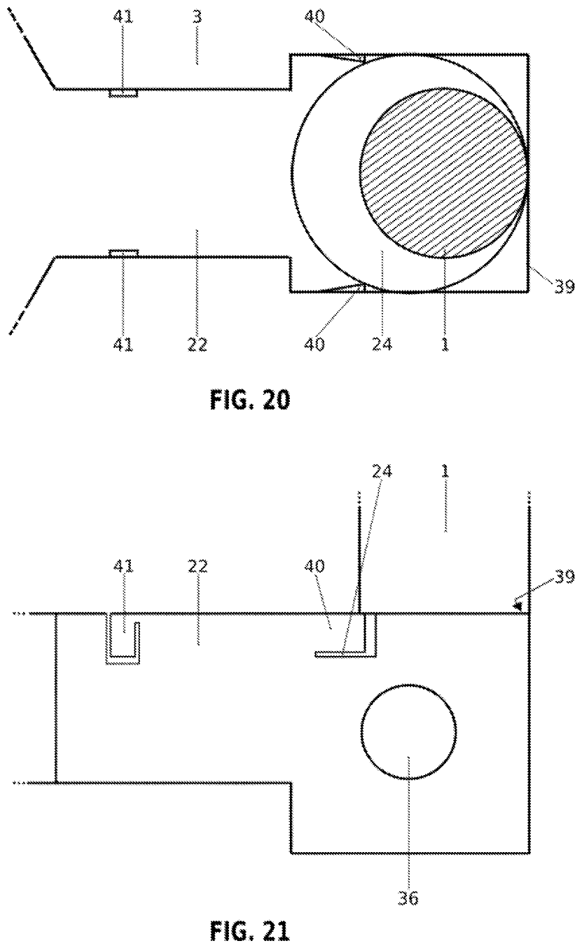

FIG. 20 shows a variant of the device of FIG. 14 in the vertical position of use, in section along a horizontal plane located at the interface between the visible part and the invisible part of the device.

FIG. 21 shows the device of FIG. 20, in its retraction casing, in a right-hand view.

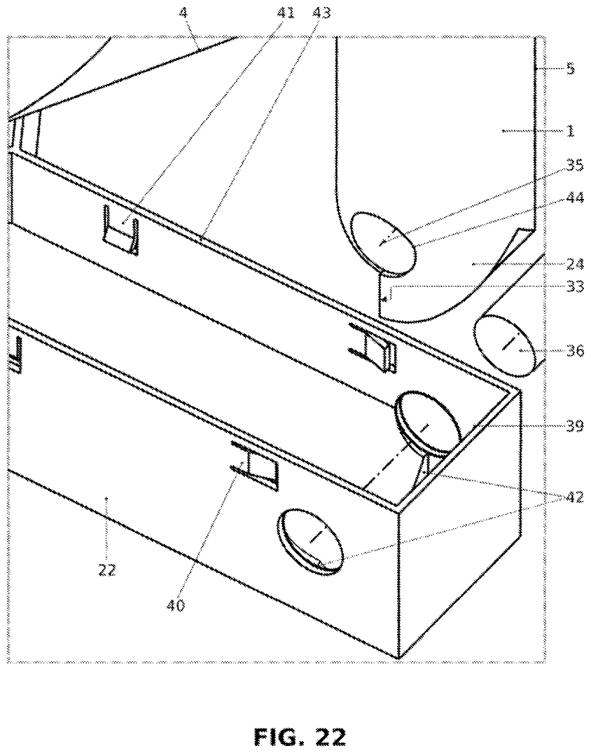

FIG. 22 shows an exploded view of the device and the retraction recess of FIG. 14.

With reference to these drawings, the device (1) comprises two oblique rods (4) of cylindrical shape (“branches”) giving it the appearance of the symmetric upper case letter “V” (in the following and by convention, the references point into the interior of the oblique rods (4) and the vertical rod (5) when it is question of the device (1) that said oblique rods (4) and vertical rod (5) constitute, but they point while remaining on an oblique rod edge (4) or on the edge of the vertical rod (5), without penetrating therein, when it is only question of said oblique rods (4) or vertical rod (5). On the other hand, when these references relate to an invisible part in the following figures, they are accompanied by an angled arrow.) The device (1) is attached to the back (2) of the casing (3) of an input/display unit. Two neighboring fingers are placed on either side of the sagittal plane (26) of the device (1), at the location where their section (6) (located in the frontal plane of symmetry (27) of the device (1), frontal plane of symmetry (27) shown in FIG. 5) causes them to be in contact, both with the underside of the oblique rods (4) and with the back (2) of the casing (3). The section finger (8) of the minimum value taken into account for the use of the considered casing (3) and therefore of the considered device (1) defines a minimum segment (7), adjacent to this section (8), and another minimum segment (7) symmetrical relative to the axis of symmetry (25) of the device (1). The minimum segments (7), the bottom of the oblique rods (4) and the back (2) of the casing (3) delimit an empty zone (11), of too small a height to be able to be occupied by any finger of the public of the type and of the age envisaged for the use of the device (1) dimensioned to be installed on this particular casing (3). In the visible part of the device (1), that the two oblique rods (4) constitute, is an invisible part (24) buried in the casing (3) when the device (1) is in use, vertically and above a casing back (2) of the casing (3). The invisible part (24) of the device (1) is used to guarantee the fastening of the device (1) to the casing (3) as well as to ensure the rotation causing the device (1) to pivot from its vertical position of use to its horizontal retracted and storage position under the back (2) and into the casing (3) (see below, FIG. 11 and FIG. 12). The invisible part (24) of the device (1) also ensures the rotation in the opposite direction causing the device (1) to exit from its horizontal retracted and storage position for its use, in the vertical position.

In the embodiment according to FIG. 2, the device (1) is used with a third section finger (6), the finger and the phalanx thereof not important, third section finger (6) placed in the overhanging area (10) located above the junction of the oblique rods (4) of the device (1), along the sagittal plane (26). The device (1), adapted to the fingers of lowest diameters, and the least realistic (thus the diameter of zero value), is, on the other hand, dimensioned only and at most, at the section (9) of finger defined by the fact that it is in contact, both with the upper end of the oblique rod (4) under which it is located and with the back (2) of the casing (3). The maximum segment (28) is associated with this maximum section (9). It follows that only the part of each oblique rod (4) overhanging the space between the maximum segment (28) and the minimum segment (7) is used, since only to be able to come into contact with a finger placed on the back (2) of the casing (3).

In the embodiment according to FIG. 3, it is added to the two oblique rods (4) of the device (1), a vertical rod (5) of cylindrical shape (a “backbone”) being placed under the junction of the two oblique rods (4) and above the invisible part (24) (“root”) of the device (1), giving this alternative of the device (1) the appearance of the “Y” symmetric uppercase letter. This variant of the “Y” device (1) is also usable with a third finger placed in the overhanging area (10) located above the junction of the oblique rods (4) of the device (1), along the sagittal plane (26).

In the embodiment according to FIG. 4, the device (1) is adapted, for the lower of each other, to the finger section (8) defined by the fact that it is in contact, both with an oblique rod (4), with the vertical rod (5) and with the back (2) of the casing (3). The minimum segment (7) is associated with the minimum section (8). The device (1) is still sized, for the strongest of each other, to the finger section (9) defined by the fact that it is in contact, both with the upper end of the oblique rod (4) under which it is located and with the back (2) of the casing (3). The maximum segment (28) is associated with this maximum section (9). Since both hands can use, in turn, the device (1), that the interdigital spaces that can be mobilized have different orientations, it is also necessary to change the orientation of the device (1) so that the oblique rods (4) of said device (1) remain perpendicular to the interdigital space separating the fingers located under the oblique rods (4) at the considered instant. For this, said oblique rods (4) have a base form a butterfly (29), with no translational rotation in the vertical rod (5).

In the embodiment according to FIG. 5, the hand slides along the back (2) of the casing (3) to enclose the device (1) inside the interdigital space (12) and between the desired phalanges (13).

In the embodiment according to FIG. 6, the device (1), installed on the back (2) of the casing (3) along the longitudinal axis of symmetry of the casing (3), to allow the use thereof using the right hand, all as much as the left hand, and installed above the center of gravity of the casing (3) for stability reasons, is clamped in a chosen interdigital space (12) between the desired phalanges (13). The butterfly (29) formed by the oblique rods (4) of the device (1) is oriented perpendicularly to the interdigital space (12) used.

In the embodiment according to FIG. 7, an intermediate finger (15) is placed above and between the two oblique rods (4) of the device (1), between the finger (14) and the finger (16) which, themselves, are under the oblique rods (4), relieving the hand of a preceding grip which would have been too long held, and always preventing the inadvertent rotation of the casing (3) since the oblique rods (4) exert a press on the finger (14) and on the finger (16) enclosing the intermediate finger (15), thus pressing the hand on the back (2) of the casing (3) and ensuring the anti-rotation stability.

In the embodiment according to FIG. 8, the central region (17) of the hand, connecting the metacarpus and the proximal phalanges, is detached from the back (2) of the casing (3), so as to form a dome allowing the air to flow and to evaporate the perspiration, which improves comfort and prevents the hand from sliding and to the casing (3) to rotate. The device (1) then uses the adapted phalanges, other than the proximal ones, which have been raised to participate in the formation of the dome of the hand.

In the embodiment according to FIG. 9, it appears that the device (1) can be grasped, by a closed hand, between the median phalanges (18), the vertical rod (5), of which the cross-section between the median phalanges (18) appears, cannot constitute an axis of rotation since there are an obstacle the oblique rods (4) clamped between the fingers and the palm of the hand and that there it prevents the contact between the top of the median phalanges (18) and the back (2) of the casing (3) against which the median phalanges (18) are pressed.

In the embodiment according to FIG. 10, it is still another type of socket wherein the device (1) is clamped between the thumb (19), the index finger (20) and the middle finger (21). This time again, it cannot be rotated around the vertical rod (5) (sectional view) since the oblique rods (4) do not form a plane that can coincide with that of the interdigital space separating the index finger (20) and the middle finger (21), oblique rods (4) that do not form a plane perpendicular to the vertical rod (5) due to the nonlinearity of said oblique rods (4), and that the contact of the thumb (19) and the index finger (20) are opposed to the back (2) of the casing (3) against which the back (2) a part of the thumb (19) and a part of the index finger (20) are applied.

In the embodiment according to FIG. 11, it is two “V” devices (1) (but nothing prevents the use of the “Y” variant, use not shown here) which are installed on the back (2) of the upper casing (3) of an device with two sections, in a direction parallel to that of the joint, the two sections here perpendicular to the vertical (30), two devices (1) which are installed side by side and so as to leave between them, devices (1), the space necessary for inserting at least one finger of the largest of the sizes of the range of which the devices (1) are provided. It appears, adjacent to each of the two devices (1), the recesses (22) wherein these devices (1) are retracted and stored after use. Each of the recesses (22) is dimensioned to also accommodate the invisible part (24) of the device (1), the invisible part (24) that is buried when the device (1) is in use, and therefore installed vertically, above a back (2) of the casing (3). The invisible part (24) of the device (1), used to guarantee the fastening of the device (1) to the casing (3) and also to ensure the rotation causing the device (1) to pivot from its vertical position of use to its horizontal retracted and storage position in the recess (22), appears when the device (1) is retracted into the casing (3) and that said casing (3) is seen from above, the limit, between the part of the recess (22) receiving the visible part of the device (1) and the part of the recess (22) receiving the invisible part (24) of the device (1), here materialized by a fictitious line (23). The hands apply to the devices (1) and take advantage of all the possibilities offered by the oblique rods (4) for gripping, holding and manipulating the casings (3). The angles (positive and different) that the inter-digital spaces make with the vertical (30) lead to the fact that the butterfly valves (29) of the devices (1) must be turned from the same angles (positive and different) to be perpendicular, both to the interdigital space concerning it, in order to ensure the optimal use of the devices (1). Having two devices (1) allows simultaneous or particular uses to this duality, in the same way as the thumb can be used as the interdigital space between its proximal phalanx and the metacarpal but also from its distal phalanx and from its proximal, which, on their own, allow the base of a device (1) to be almost entirely enclosed.

In the embodiment according to FIG. 12, it is two devices (1) in “Y” (but nothing prevents the use of the “V” variant, use not shown here) which are installed on an device with two sections, along a horizontal line located above the center of gravity of the assembly for a reason of stability, devices (1) installed on the back (2) of the two casings (3), on either side of the joint of the two sections here aligned with the vertical (30), two devices (1) installed side by side and so as to leave between them, devices (1), the space necessary for inserting at least one finger of the largest of the sizes of the range of which the devices (1) are provided. It appears, adjacent to each of the two devices (1), the recesses (22) wherein these devices (1) are retracted and stored after use. Each of the recesses (22) is dimensioned to also accommodate the invisible part (24) of the device (1), the invisible part (24) that is buried when the device (1) is in use, and therefore installed vertically, above a back (2) of the casing (3). The invisible part (24) of the device (1), used to guarantee the fastening of the device (1) to the casing (3) and also to ensure the rotation causing the device (1) to pivot from its vertical position of use to its horizontal retracted and storage position in the recess (22), appears when the device (1) is retracted into the casing (3) and that said casing (3) is seen from above, the limit, between the part of the recess (22) receiving the visible part of the device (1) and the part of the recess (22) receiving the invisible part (24) of the device (1), here materialized by a fictitious line (23). The hands are applied to the devices (1) and take advantage of all the possibilities offered by the oblique rods (4) and the vertical rods (5) for gripping, holding and manipulating the casings (3). The angles (negative and different) that the interdigital spaces are made with the vertical (30) lead to the fact that the butterflies (29) of the devices (1) must be turned from the same angles (negative and different) to be perpendicular, both to the interdigital space concerning it, in order to ensure the optimal use of the devices (1). Having two devices (1) allows simultaneous or particular uses to this duality, in the same way as the thumb can be used as the interdigital space between its proximal phalange and the metacarpus but also from its distal phalanx and from its proximal side, which, on their own, allow the base of a device (1) to be almost entirely enclosed, the use of the distal and proximal phalanges of the thumb also with the mobilization of any of the four fingers which then must apply to the second device (1).

In the alternative embodiment according to FIG. 14, the device (1) and its recess (22) are presented in modular form, that is with a recess intended to be subsequently integrated into a cavity of complementary shape provided for this purpose in the back of the casing. In the variant described here, the two lateral walls (23) of the recess (22) containing the invisible part (24) comprise two tabs opposite, here two horizontal rectangular tabs (40), configured to stabilize the device (1) in the vertical position of use. The recess (22) also comprises two other opposite tabs, here vertical rectangular tabs (41), configured to stabilize the device (1) in the recess (22) in the horizontal retraction and storage position. In the embodiment described herein, the two vertical rectangular tabs (41) are located in side walls (43) of the recess (22) containing the vertical rod (5) opposite to each other but the vertical rectangular tabs (41) could equally well be located in opposite side walls (43) with one or other of the oblique rods (4). The two vertical rectangular tabs (41) and the two horizontal rectangular tabs (40) are cut on three of their sides in the side wall (43) that they occupy. Advantageously, it will be noted that the device (1), in the vertical position of use, is, by its invisible part (24), in contact with the interior of the rear face (39) of the recess (22).

When the device is in the vertical position of use, the device (1) is located too far from them so that the vertical rectangular tabs (41) can exert any action on said device (1). On the contrary, the horizontal rectangular tabs (40) project outside the side walls (43) of the recess (22) and are in contact with the invisible part (24) of the device (1). The horizontal rectangular tabs (40) then apply a force holding the device (1) in its vertical position of use as long as an upper force exerted in the opposite direction does not force the device (1) to save its horizontal retraction and storage position.

In FIG. 13, the device (1) of FIG. 14 is shown in top view in the horizontal retraction and storage position in the recess (22) and shows, separated from the rest of the device (1) by the imaginary line (23), the invisible part (24), buried in the recess (22) and therefore subsequently in the casing (3). The invisible part (24) is present, in the variant described here, as a vertical mini-rod extending the vertical rod (5). It will be noted that the tipped hypothetical line (31) isolates two left double-curvilinear small triangles (38) enclosing a large double-curvilinear left triangle (37). Here too, the invisible part (24) is in contact with the inside of the rear face (39) of the recess (22) as explained in more detail below. Here, the two horizontal rectangular tabs (40) are installed too high to have contact with said invisible part (24) in this retracted position of the device (1). On the other hand, the vertical rectangular tabs (41) are in contact with the device (1) and exert on said device (1) a force constraining it to remain in this horizontal retracted position until an upper opposing force comes out of the device (1) of the recess (22) for the rotation of the drive in the vertical position of use.

In FIG. 15, the upper section, carried out along a plane tangent to the upper face of the horizontal rectangular tabs (40), causes the invisible part (24) to appear, still in contact, by the large double-curvilinear left triangle (37) with the inside of the rear face (39) of the recess (22), forcing a horizontal rectangular tab (40) to enter a side wall (43) of the recess (22) corresponding to the invisible part (24) of the device (1), so as to be able to pass to reach the vertical position of use.

In the lower section of FIG. 15, the invisible part (24) having reached the vertical position of use, in contact with the interior of the rear face (39) of the recess (22) via the large double-curvilinear left triangle (37), the horizontal rectangular tab (40) can then escape from the side wall (43) of the recess (22) corresponding to the invisible part (24) of the device (1) and to stabilize the invisible part (24) and, therefore, the device (1), in the vertical position of use.

In FIG. 16, the left-hand cut, carried out along a plane tangent to the front face of the vertical rectangular tabs (41), causes the vertical rod (5) to appear near the horizontal storage position in the recess (22), forcing a vertical rectangular tab (41), cut into the part of the recess (22) corresponding to said vertical rod (5), to enter the side wall (43) of the recess (22) corresponding to said vertical rod (5). In other embodiments mentioned above, the oblique rod (4) can force a vertical rectangular tab (41) cut into the part of the recess (22) corresponding to the oblique rod (4) to enter the side wall (43) of the recess (22) corresponding to said oblique rod (4)), so as to allow the device (1) to pass to reach its horizontal storage position.

In the right-hand section of FIG. 16, the device (1), having reached its horizontal storage position in the recess (22), the vertical rectangular tab (41) can then come out of the side wall (43) of the recess (22) and stabilize the device (1) in a horizontal storage position.

In FIG. 17, the device (1), taken out of its recess (22) and seen from the right, causes to appear, under the imaginary line (23), the invisible part (24), not yet pierced of the cylindrical hole (44), the function of which is explained later (the cylindrical hole (44) being not yet pierced, it is, for this reason, shown as a dashed line). In the embodiment described here, said invisible part (24) has the same diameter as that of the rods of the device (1) and also a height equal to this diameter. It is crossed, in its middle and vertically, by the front plane of symmetry (27) and passes through it again, through the horizontal middle plane (50). The intersection of the frontal plane of symmetry (27) and of the horizontal middle plane (50) defines the axis of rotation of the device (1). As explained above, it is provided to pierce a cylindrical hole (44) having, as axis of revolution, the axis of rotation (35) of the device. The cylindrical hole (44) is intended to accommodate a hub (36) intended to allow the rotation of the device (1) from its vertical position of use to its horizontal retraction and storage position. The third quadrant (45) and the fourth quadrant (46) are the right faces, respectively, of a parallelepiped of quadrant three (47) and of a parallelepiped of quadrant four (48) of which the common central ridge of parallelepipeds (49), of length equal to the diameter of the invisible part (24), is twice the length of the edges of the square faces of the parallelepiped of the quadrant three (47) and the double of the length of the ridges of the square faces of the parallelepiped of quadrant four (48), is located on the axis of rotation (35) (in dashed line indicating the notional nature, as are imaginary the parallelepipeds of the quadrants). The cross-hatching indicates that the material composing the invisible part (24) contained in the parallelepiped of the quadrant thee (47) and the material of the invisible part (24) contained in the parallelepiped of the quadrant four (48) will be removed so as to trim the front half-cylinder and the rear half-cylinder of the invisible part (24), the trimming of front half-cylinder and the trimming of rear half-cylinder revealing, in the figure, respectively, a three-quadrant arc three (51) and a quarter-circle arc of a four quadrant (52) (trimming, not yet performed, means that the three-quadrant circular arc (51) and the four-quadrant arc four (52) are shown in dashed lines). The simple hatching indicates a partial removal of material composing the front half-cylinder of the invisible part (24) contained in the parallelepiped of the quadrant three (47).

In FIG. 18, the invisible part (24), separated from the rest of the device (1) by the imaginary line (23) is, for the part of its front half-cylinder contained in the quadrant parallelepiped three (47), cut to take the appearance of a quarter-sphere (32) framed by two movable single-curvilinear isosceles rectangle triangles (33), corresponding to isosceles rectangle triangles with curvilinear hypotenuse, located at the interface between the front and rear half-cylinders of the invisible part (24). It will be noted that the two movable single-curvilinear isosceles rectangle triangles (33) belong to the front plane of symmetry (27) of the visible part of the device.

In FIG. 19, the same device (1), seen from three-quarters rear, appears separated, by the imaginary line (23), of its invisible part (24) crossed by the cylindrical hole (44) arranged for the purpose of allowing the rotation ensuring the storage and deployment of said device (1). It will be recalled here that the axis of revolution of the cylindrical hole (44) corresponds to the axis of rotation (35) of the device (1) allowing the storage and deployment thereof. The two movable single-curvilinear isosceles rectangle triangles (33) frame the quarter-sphere (32) in the same way. A horizontal quarter-cylinder (34), part of a cylinder, the axis of revolution of which consists of the common central ridge of parallelepipeds (49) and whose diameter is equal to that of the invisible part (24), is contained in the quadrant of four (48) (its dotted line indicates the imaginary character). The part of the rear half-cylinder of the invisible part (24) contained in the four-quadrant parallelepiped (48) and exterior to the horizontal quarter-cylinder (34) is trimmed, revealing, on the rear half-cylinder of the invisible part (24), at the intersection with the horizontal quarter-cylinder (34), a large double-curvilinear left triangle (37), framed by two small double-curvilinear left triangles. It will be noted that the small double-curvilinear left triangles (38) are signaled by the tipped imaginary line (31), their third side being provided. The trimming of the rear half-cylinder of the invisible part to obtain a large double-curvilinear left triangle (37) makes it possible to reduce the dimensions of the part of the recess enclosing the invisible part by bringing the rear face (39) of the recess (22) closer to the invisible part, so that the rear face (39) of the recess (22) is always adjacent to the large double-curvilinear left triangle (37) during the rotation. In the absence of bottom trimming of the rear half-cylinder of the invisible part (24), the rear face (39) of the recess would be further from the rear of the invisible part (24), which increases the bulk and has the risk of being able to contain dirt that can prevent the device from rotating. The large double-curvilinear left triangle (37) resulting from the trimming is thus, or the rotational position between the vertical position of use and the horizontal retraction and storage position, always tangent inside the rear face (39) of the recess (22). Thus, the large double-curvilinear left triangle (37) defines a so-called contact surface at least part of which is tangent to the interior of the rear face (39) of the recess (22) during the rotation of the device (1).

FIG. 22 is a partial exploded view showing the device (1) in the “Y” variant, an oblique rod (4), the vertical rod (5), the invisible part (24) pierced with the cylindrical hole (44) having to receive a hub (36) so as to ensure the rotation of the device about the rotation axis (35) between the vertical use position and the horizontal retraction and storage position. The hub (36) is also used to secure the device (1) with the recess (22) by positioning the device (1) vertically for its use while it is held in this vertical position both by the double contact on the one hand from the rear of the invisible part (24) via the large double-curvilinear left triangle (37) with the inside of the rear face (39) of the recess (22) and, on the other hand, of the two movable single-curvilinear isosceles rectangle triangles (33) of the invisible part (24), applied against the two stationary single-curvilinear isosceles rectangle triangles (42) of the recess (22), than by the pressure of the horizontal tabs (40) protruding outside the side walls (43) of the recess (22) wherein they have been arranged. The hub (36) also connects the device (1) with the recess (22), in the retracted and storage position, horizontally, holding it, in this retracted position, by, on the one hand, in contact with the bottom of the recess (22) and, on the other hand, the pressure of the vertical tabs (41) exiting the side walls (43) of the recess (22) wherein they have been created. It will be noted that the rotation of the device between the retracted and storage position and the vertical position of use is made possible by the presence of a quarter-sphere (32) on the front half-cylinder whose shape is adapted to pass above the two stationary single-curvilinear isosceles rectangle triangles (42) for abutting the recess during rotation. It will be noted that the two fixed single-curvilinear isosceles rectangle triangles (42) correspond to isosceles rectangle triangles with curvilinear hypotenuse arranged such that the right angle sides are parallel to the bottom wall and to the side walls of the recess (22). Moreover, the two hypotenuses placed end-to-end forming a semi-circle adapted to receive the quarter-sphere part (32) during the rotation of the device.

FIG. 20 is a cross-section of a top view of the device (1) in the vertical position of use, cutting carried out along a horizontal plane located at the interface between the invisible part (24) and the visible part of the device (1). In this alternative embodiment, the section of the invisible part (24) and the part of the recess (22) containing the invisible part (24) are of dimensions greater than those described above with reference to FIGS. 13 to 19. These dimensions are enlarged so as to increase, as much as necessary, the solidity and, therefore, the solidity of the fastening of the device (1) to the recess (3). Thus, in this alternative embodiment, the diameter of the invisible part (24) is greater than the diameter of the vertical rod (4). It will be noted that, in this case, the invisible part (24) of the device (1) is enlarged homothetically relative to the invisible part (24) described with reference to FIGS. 13 to 19 while remaining flush with the recess (22), as a result of which enlargement of the invisible part (24) of the device (1), is enlarged the part of the recess (22) containing this invisible part (24), enlarging the invisible part (24) holding the visible part of the device (1) in the vertical position of use unchanged plumb with the rear of the recess (22). Therefore, this invisible part (24) is no longer concealed, in top view, by the visible part of the device (1) in the vertical position.

It will be noted that in the case of a V device not comprising a vertical rod in its visible part (see FIG. 1), the invisible part (24) also has the shape of a cylinder with an axis of revolution corresponding to an axis of symmetry (26) of the device (1) located under the junction with the two oblique rods (4). The diameter can then be chosen greater than the diameter of the oblique rods (4) in order to increase the strength thereof and, therefore, the strength of the fastening of the device (1) to the casing (3). It will be noted that the visible part of the device (1) is defined to be suitable for different predefined finger sizes by adjusting the length and arrangement of the oblique rods (angle and length of the oblique rods, height of the vertical rod for “Y” devices). Furthermore, the visible part of the device, and more particularly the diameter of the vertical rod, can also be defined as a function of the interdigital spaces between the fingers intended to use the device.

FIG. 21 shows for this same variant, the invisible part (24) and the part of the recess (22) containing the invisible part (24), enlarged in three dimensions, the invisible part (24) remaining to be flush with the recess (22) in an unchanged manner with respect to the situation before enlargement, while remaining in contact with the interior of the rear face (39) of the recess (22), recess (22) whose part corresponding to the invisible part (24) is extended by a length corresponding to the enlargement of this invisible part (24).

As a non-limiting example, the device will have dimensions of the order of 2.5 cm length for each of its oblique rods (and 1 cm for its vertical rod when it is present) with, for the latter (and for the latter, if there is place) a diameter of 0.5 cm, forming one (two) angle(s) of 120 degrees between them (they are three, if necessary).

The device according to the invention is particularly intended for tablets, e-readers and laptop computers.

1. A device for gripping, holding in the hand and handling of an input/display unit characterized in that it consists, for its visible part when in its vertical use position, of two non-collinear cylindrical oblique rods+attached to the back of the casing of the display device, having the appearance of the letter “V”, oblique rods under which the fingers of one hand slide so that the hand is sandwiched, the back of said hand against the bottom of the oblique rods and, the palm, against the back of the casing, which has the effect of securing the hand with the casing, the outlet being reinforced by the natural movement bearing the fingers to be clamped against one another and therefore also to tighten on the base of the device where the two oblique rods meet, which results in keeping the casing secured to the hand, the device being released and, with it, the casing, as soon as an effort is exerted to separate the fingers enclosing the base of the device.

2. The device according to claim 1, characterized in that, under a junction of the two oblique rods, a vertical rod is located, the visible part of the device then being in the form of a “Y”.

3. The device according to claim 1, characterized in that the oblique rods are combined in the construction of a butterfly with no translational rotation.

4. The device according to claim 1, characterized in that a recess, in the form of a “Y”, is arranged on the back of the casing, configured to receive, from said device, the visible part appearing above the back of the casing, and to also receive, from the device, an invisible part located in the casing when the device-is in the vertical position above the back of the casing, the invisible part being configured to guarantee the fastening of the device to the casing as well as to ensure a rotation, pivoting the device, making it possible to store and retract said device-in the recess.

5. The device according to claim 4 characterized by the fact that two horizontal tabs and two vertical tabs are respectively cut on side walls of the recess opposite each other, the two horizontal tabs being arranged opposite each other and the two vertical tabs being arranged opposite each other, the horizontal tabs being configured to be protruding and in contact with the invisible part when the device is in its vertical position of use so as to stabilize the device in the vertical position of use, the vertical tabs being configured to be protruding and in contact with the visible part when the device is in its horizontal retracted and storage position so as to stabilize the device in the horizontal retracted and storage position, the horizontal tabs and the vertical tabs being further configured be able to rotate the device from the vertical position of use in the horizontal retraction and storage position, and vice versa, when a force making it possible to overcome the stabilization exerted by the tabs is applied to said device.

6. The device according to claim 4, characterized in that the invisible part has the shape of a cylinder with an axis of revolution corresponding to an axis of symmetry of the device, the invisible part comprising a front half-cylinder and a rear half-cylinder, the bottom of the front half-cylinder being trimmed to take the appearance of a quarter of a sphere framed by two abutment surfaces formed by two first isosceles rectangle triangles with movable curvilinear hypotenuse, the bottom of the rear half-cylinder being trimmed so as to have a contact surface always tangent to the inside the rear face of the recess during the rotation of the device, the recess further comprising a part formed by two isosceles second rectangle triangles with fixed curvilinear abutment hypotenuse, meant to enter in contact with the two opposite abutment positions, when the device, in rotation, reaches it vertical position of use, preventing the device from rotating the driving element beyond its vertical position of use.

7. The device according to claim 6, characterized in that the invisible part of the device is of a diameter greater than a reference diameter of the visible part of the device, the corresponding reference diameter, or to the diameter of a vertical rod being located under a junction of the two oblique rods, or to the diameter of the two oblique rods, in the absence of a vertical rod under the junction of the two oblique rods.

8. A system for gripping, holding by hand and handling of an input/display unit characterized in that the system comprises two devices according claim 1, the two devices being attached to the back of the casing of the input/display unit, or being attached to the back of the two casings of the input/display unit when the input/display unit comprises two sections, so that it is either the base of one and/or the other device which is enclosed by neighboring fingers, or both devices, both which are taken, both, as if they were only made a single device, virtual, by distant fingers, thus a device by the thumb and, the other device, by the ear.
